(19) United States
(12) Patent Application Publication
(10) Pub. No.: US 2026/0281198 A1
(43) Pub. Date: Sep. 17, 2026

(54) UNIQUE CONTENT DESCRIPTORS SYSTEM AND METHOD

(71) Applicant: Persona IP Licensing, LLP, Austin, TX (US)

(72) Inventor: James Eustace, Austin, TX (US)

(73) Assignee: Persona IP Licensing, LLC, Austin, TX (US)

(21) Appl. No.: 19/080,195

(22) Filed: Mar. 14, 2025

(51) Int. Cl. H04L 67/50

(52) U.S. Cl. CPC H04L 67/535

(57) ABSTRACT

A method includes detecting indicators of actions and inactions of a user device communicatively connected to a data communications network, delivering the indicators to a descriptor generator communicatively connected to the data communications network, and transforming the indicators to a prompt of respective unique descriptor for the user device. The transforming may include calculations or decisions by the descriptor generator that relate to behaviors (actions and inactions of the user device, gender or identity of the user of the user device, geographic locale of the user device or user, past and present situation of the user device or user, other indicia, behavioral indicators of similarly postured user devices, other societal experiences and norms indicative of and relevant to the user and user device, and other indicia, and combinations of these). The unique descriptor is prompt to a generative learning engine, to provide contextualized response for display and other output or operations of the user device.

### TECHNICAL FIELD

The present disclosure relates generally to communications networks and devices, and, more particularly, relates to unique descriptors of or associated with behaviors of networked communications devices.

### BACKGROUND

It is possible to uniquely identify respective user devices communicatively connected to a data communications network by detected experiences and behaviors of those user devices. The unique identifications may include, as example but not limitation, such items as individualized details of the user of the user device, actions and inactions and other behaviors exhibited by the user device on the data communications network, content received or output by the user device, and measured experiences of the user device. Individual descriptors for respective user devices may be employed by servers and other systems of the communications network to deliver particular content items or to otherwise address the user devices.

Although individual descriptors may be so employed, there has not been any use of those descriptors in a unique manner for each unique user device with a generative process, such as an artificial intelligence system for creating unique content for the unique user device.

It would, therefore, be advantageous to provide systems and methods for deriving unique descriptors of behaviors and experiences for a unique user device of a communications network, which behaviors may include items of the unique user device, such as its actions and inactions, items associated with other devices of behavioral relevance, optimized or projected patterns, and other particulars for the unique user device. It would further be an advantage to iteratively learn the behaviors corresponding to the unique descriptors for the unique user device, as well as other devices. Further advantages may include, for example, machine learning to generate unique content items for the unique user devices based on the unique descriptors.

### SUMMARY

An embodiment of the invention is a system for generating unique descriptors of a user device communicatively connected to a generative engine. The system includes a descriptor generator communicatively connected to the user device. The descriptor generator detects actions and inactions of the user device, transforms the actions and inactions to respective unique descriptor for the user device, and makes available the respective unique descriptor to the generative engine for delivering unique instructions to the user device.

Another embodiment of the invention is a system for generating unique descriptors of a user device communicatively connected to a data communications network. A generative engine is communicatively connected to the data communications network. The system includes a server device communicatively connected to data communications network, and the server device intermediates communications of the user device on the data communications network. The system also includes a descriptor generator communicatively connected to the server device. The descriptor generator detects actions and inactions of the user device on the data communications network, transforms the actions and inactions to respective unique descriptor for the user device, and makes available the respective unique descriptor to the generative engine for delivering unique instructions to the user device.

Yet another embodiment of the invention is a method that includes detecting indicators of actions and inactions of a user device communicatively connected to a data communications network, delivering the indicators to a descriptor generator communicatively connected to the data communications network, transforming the indicators to a prompt of respective unique descriptor for the user device, and delivering the prompt to a generative learning engine communicatively connected to the data communications network.

### BRIEF DESCRIPTION OF THE DRAWINGS

The present invention is illustrated by way of example and not limitation in the accompanying figures, in which like references indicate similar elements, and in which:

FIG. 1 illustrates a system for generating unique descriptors for prompt to a generative learning engine, according to certain embodiments of the invention;

FIG. 2 illustrates a system for generating unique descriptors for prompt to a generative learning engine, including a social media network server device, according to certain embodiments of the invention;

FIG. 3 illustrates a method of operation of a server or processing device generating unique descriptors for prompt to a generative learning enginge, according to certain embodiments of the invention;

FIG. 4 illustrates a method of operation of a system for collecting behaviors of a user device for generating unique descriptors, according to certain embodiments of the invention;

FIG. 5 illustrates a method of operation of a system of a server computer intermediating communications for behaviors of a user device, for generating unique descriptors, according to certain embodiments of the invention;

FIG. 6 illustrates a method of operation of a server device or other intermediary device, such as a social media network server device or otherwise, for generating unique descriptors, according to certain embodiments of the invention; and

FIG. 7 illustrates a method of operation of a descriptor generator, according to certain embodiments of the invention.

### DETAILED DESCRIPTION

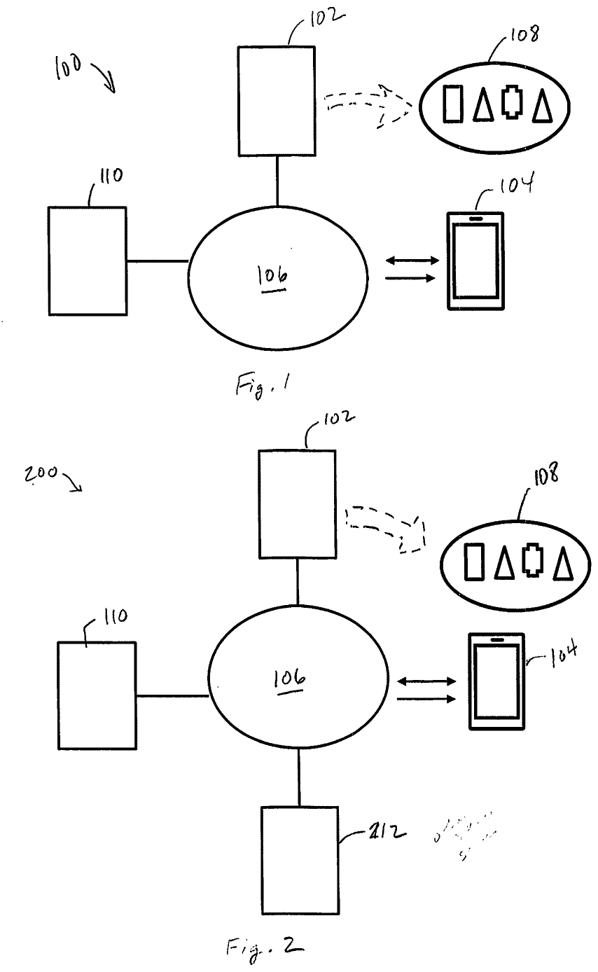

Referring to FIG. 1, a system 100 includes a descriptor generator 102. The descriptor generator 102 is communicatively connected to a user device 104, such as by a data communications network 106. A learning machine 110 may be communicatively connected to the network 106.

The descriptor generator 102 is or includes, in whole or part, hardware components, for nonexclusive example, a processing device with memory and bus, software modules, for nonexclusive example, software stored in a tangible medium and processed by a processor, or combinations. The descriptor generator 102 includes or communicatively connects to hardware, software, or combinations for communications of the descriptor generator 102 on the network 106. In certain nonexclusive embodiments, the descriptor generator 102 is one or more of a server computer, data processor, signal processor, circuit, software program in memory operated by a processor, database, or combinations of any of these.

In any event, the descriptor generator 102 detects or ascertains actions (which may include inactions) of the user device 102 with respect to a content item, that is proxy to the previous or last in time experience of the user device 102, such as for nonexclusive example, a website, article, video, message, text, or other digital artifact or item. The content item may be available from the network 106 via access by the user device 104 to a server or intermediary device of communications of the network 106 (which may include or not the descriptor generator 102, according to nonexclusive embodiments), or the content item may otherwise be accessed by or included in the user device 104. In certain nonexclusive embodiments, the descriptor generator 102 obtains or detects the actions (which may include inactions) from another source device, such as for nonexclusive example as later described. Upon receiving signals indicative of the actions (or inactions, as applicable) from the network 106 by the descriptor generator 102, the descriptor generator 102 transforms actions (and inactions, as applicable) of the user device 104 to respective unique descriptors 108.

The user device 104 is a data processing device, such as a smartphone, tablet, computer, or other device, capable of input of and output to a human user, a separate system or process, or otherwise. The user device 104 may be hardware components, for example, a processing device with memory and bus, software modules, for example, software stored in a tangible medium and processed by a processor, or combinations. The user device 104 may include or communicatively connect to hardware, software, or combinations for communications of the user device 104 on the network 106. Actions of the human user to input (or not) to the user device 104 are communicatively made available to the descriptor generator 102, such as for nonexclusive example over the network 106.

The data communications network 106 is any one or more wired or wireless communicative link or plurality of communicative links. A nonexclusive example of the network 106 is any one or more of a wired, cable, wireless, optic fiber, cellular, wide area network (WAN), local area network (LAN), wireless local area network (WLAN), satellite or other communicative link, now or hereafter available, or combinations of any of these. Although the network 106 is shown in the Figures as unitary, the network 106 may include any combination of communicative links, with certain or all links that are segregated from certain other links. In certain exemplary embodiments, the user device 104 communicates over the network 106 with the descriptor generator 102 upon actions (or inactions, as applicable) of the user device 104.

In operation, upon detecting, receiving, collecting, or otherwise obtaining or accessing actions (and inactions, as applicable) of the user device 104, the descriptor generator 102 processingly transforms these actions/inactions to respective unique descriptors 108 for the user device 102. The unique descriptors 108 have format configured for input to the learning machine 110. For nonexclusive example, the descriptor generator obtains actions/inactions of the user device, generates respective unique descriptors 108, and delivers the unique descriptors 108 over the network 106 to the learning machine 110. The learning machine is, for nonexclusive example, an Al content generator that outputs unique content in respect of the unique descriptors 108. The unique content is provided to the user device 104 over the network 106. Specific nonexclusive examples of the learning machine 110, may be any generative platform, such as Midjourney, DALL E2, or any other generative service or device.

Referring to FIG. 2, a source server device 112 is communicatively connected to the network 106 of FIG. 1. The source server device 112 represents any intermediary of communications of the user device 104 in the network 106. As intermediary, the source server device 112 receives communications of the user device 104 and communicates over the network 106 with the descriptor generator 102 corresponding to the actions/inactions of the user device 104.

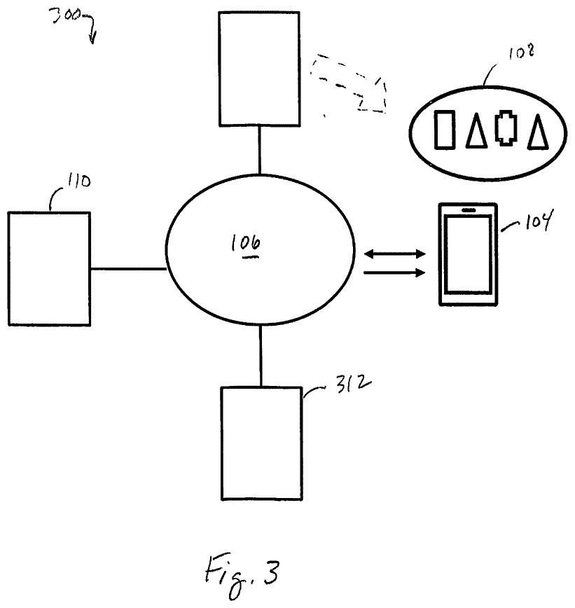

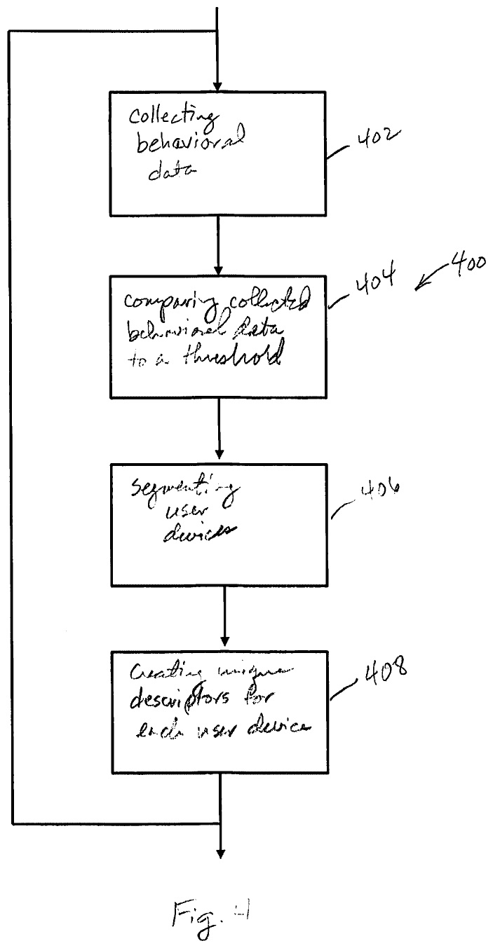

Referring to FIG. 3, a social media network server device 312 or other server or processing device or platform, detects, collects, and makes available, such as via an application programming interface (API), internally to the server or processing device or platform, or otherwise, indicators of actions (and inactions, as applicable) of the user device 104. The descriptor generator 102 may directly or indirectly access over the network 106 the social media network server device 112, such as via the API or otherwise, to obtain the indicators and/or unique descriptors.

In other alternatives or additions, the social media network server device 312, or another similar device, may detect, collect and make available, such as via API, indicators of actions (and inactions, as applicable) of segments or sets of pluralities of user devices. These indicators for segments or sets of user devices may correspond to the pluralities of user devices exhibiting similar behaviors (e.g., actions and/or inactions) of the respective user devices of the segments or sets. The descriptor generator 102 may access, directly or indirectly, over the network 106 the social media network server device 312, such as via the API or otherwise, to obtain the indicators.

In even further alternatives or additions, the source server device 112, the social media network server device 312, or another similar device, including the user device 104 itself, may process actions (and inactions, as applicable) of the user device 104, as well as other user devices, and make available for access, marketing, behavioral data, or collective data of user devices acting with similarity or dissimilarity, or complementary in any manner, to the user device 104. This marketing or collective data corresponds to exemplary behaviors or other behaviors of the user device 104, and may be accessed over the network 106 by the descriptor generator 102, either directly or indirectly. Although the source server device 112 and the social media network server device 312 are illustrated in embodiments as networked and separate entity(ies) from the user device 104, it should be understood that the user device 104 may, itself in certain embodiments, in conjunction with other devices or elements in certain other embodiments, or via or in conjunction with another source in certain further embodiments, may collect the indicators of action and inaction, that is, the behavioral experiences, of the operator of the user device 104 and/or derive the unique descriptors for those indicators. In any event, the actions and inactions, i.e., behavioral characteristics, of the user device 104 is available or made available in form of a unique content descriptor, as hereafter described.

Sources of data operative by the descriptor generator 102 are widely varied, according to embodiments. Any data source accessible to the descriptor generator 102, such as over the network 106 or otherwise, may be employed by the descriptor generator 102 to transform actions/inactions indicative of behaviors of the user device 104 to the unique descriptors 108. Moreover, the descriptor generator 102 may be programmed with rules or schema that skews or directs the transformations. For nonexclusive example, the descriptor generator 102 may, itself, employ a learning engine, which may or may not be guided or limited, to transform actions/inactions of the user device 104 to generate the unique descriptors 108.

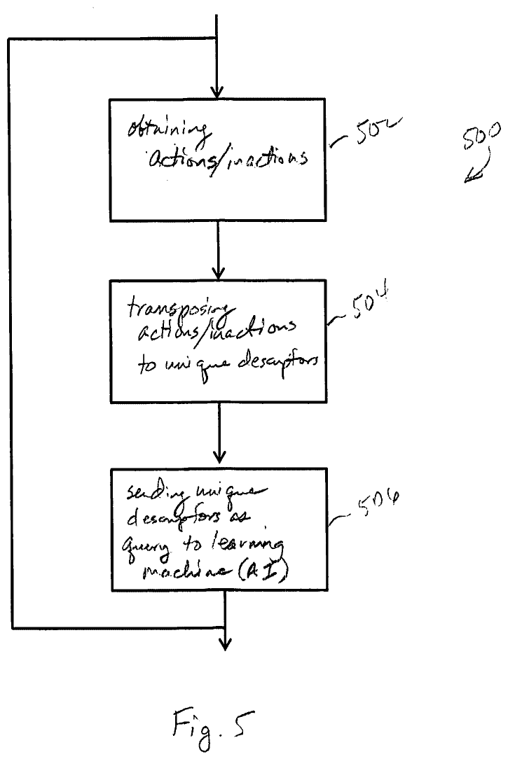

Referring to FIG. 4, a method 400 of operation of a system for unique descriptors of or associated with behaviors of networked communications devices includes collecting behavioral data 402 of or related to a user operated device. The collecting 402 may be performed by a server computer communicatively connected to the user device, a communication device or devices intermediating communications of the user device, the user device itself, any combination of these, or otherwise. The behavioral data of collecting 402 may or may not, as applicable, be compared 404 to one or more behavioral data threshold. For any excess or discrepancy of or related to the threshold, the user device may be segmented 406, such as with other similarly operative user devices, behavioral characteristics, functionalities, identities, and other characteristics or exhibitions that categorize or uniquely position the user device by itself or with other similarly disposed devices. Unique descriptors are created 408 for the user device. The unique descriptors of creating 408 are then available for further operations by any of a large language or Al model, generative model, or the like.

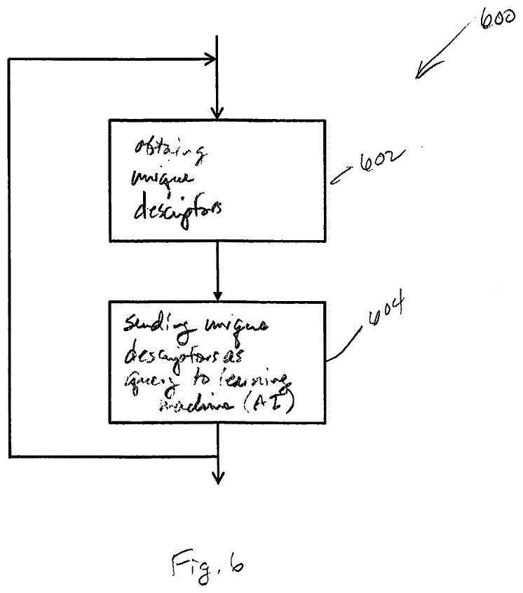

Referring to FIG. 5, a method 500 of operation of a system for a server computer includes obtaining actions and inactions 502 of a user device via communications over a digital or other computer or electronic transmission network. The server computer transposes 504 the actions and inactions to unique descriptors of the actions/inactions for the user device. These unique descriptors may be sent or input to a learning machine, such as a generative Al large language model computing system, other learning system, or the like.

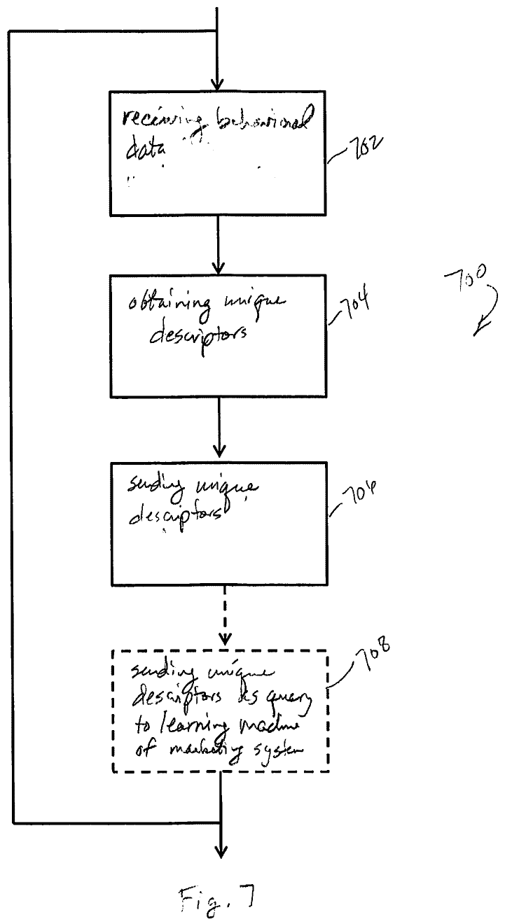

Referring to FIG. 6, a method 600 of operation of a server device or other intermediary, recipient or collector of behavioral data, or the like, of a user device, includes obtaining unique identifiers 602 for a user device, such as from the server computer, the user device itself, a social media network server device, or other device or source. In certain nonexclusive embodiments, the unique identifiers may be communicated to the learning machine over a telecommunications network, by the user device, within the user device itself if equipped with the learning machine or portions thereof, by another device intermediating communications of the user device, such as a social media network server device, another intermediary device, or otherwise.

Referring to FIG. 7, a method 700 of operation of a descriptor generator, such as a server device, a social media network server device, a user device itself, or other device or system or combination, includes receiving behavioral data 702 for a user device of the unique identifiers. The behavioral data may be received from any of a number of sources or combinations of source, including for nonexclusive example, a server device or other intermediary of communications of the user device, a social media network server device of the user device, the user device itself, or another source device or element. From the behavioral data, unique descriptors are obtained 704 by the descriptor generator. The unique descriptors may be created, transformed, manipulated, calculated, and/or selected or otherwise determined, by the descriptor generator. The descriptor generator sends the unique descriptors 706 for further processing, such as for delivery over a data communications network, to internal or communicatively connected devices, systems, or elements, or otherwise. In certain nonexclusive embodiments, the unique descriptors are sent 708 to a learning machine, such as a generative Al large language model computer system, other learning system or device, for further processing. Of course, in alternatives, various systems, features, elements, processes, operations, and other aspects may be unitized, disparate, combined, or otherwise incorporated.

In any event, the descriptor generator transforms an action (which may include inaction) of a user device related to the content item, to a unique digital descriptor. The unique digital descriptor may itself be transformed by a learning machine, such as for nonexclusive example, an artificial intelligence engine that outputs an artificial intelligence (Al) artifact or item corresponding to the unique digital descriptor. The learning machine in certain nonexclusive embodiments may be communicatively connected by a network to a descriptor generator 102. In other certain nonexclusive embodiments, the learning machine may include or connect to another source of the unique digital descriptor.

In operation, the descriptor generator accesses or otherwise communicatively obtains or accesses via the network a digital or other signal indicative of an action (or inaction, as applicable) of the user device. The descriptor generator transforms the signal indicative of the action, to the unique digital descriptor. The unique digital descriptor is readable by the learning machine. The descriptor generator communicatively delivers the unique digital descriptor to the learning machine, such as via the network, circuit, element, device, combination, or otherwise. Responsive to receiving the unique digital descriptor, the learning machine generates the Al artifact or item. The Al artifact or item may be, for nonexclusive example, a generated image, picture, text, or other message or article.

### Nonexclusive Examples

1. Content from the individual's last Experience (i.e., behaviors, including such indicators as actions/inactions and otherwise) is translated into prompt values:
   Combining at least but not limited to past experiences of the individual and user device (their behavior, their gender, both of those in the context of their current situation, both of those in the context of societal experiences and norms) or inferences made from those past experiences which are not known and are yet to be experienced.
   For example, this applied to a virtual reality (VR) experience highly personalized for the user/device. In the example, the user/device is in a VR generated jungle and the user/device takes an action which cues a game of the VR jungle to display content that is, in the example, scary to the user of the device. Based on context drawn from the norm for the user/device, which may include experiences of other similar users or otherwise, the descriptor generator generates a description of a snake. However, if the user of the device is in real life a snake handler at a zoo and various data sources show pictures of user happily holding snakes, the descriptor generator may instead generate a description of a snake that is caught in a tough spot-that is, something highly personal to this user/device.
2. Prompt values are adjusted/optimized based on behavioral data from all users.
3. Prompt values may be further adjusted/optimized based on behavioral data unique to the individual.
4. Prompt is sent to the content creation engine.

### Nonexclusive Example Prompts

In keeping with the above examples and concepts, the systems and methods derive, optimize, and combine unique content descriptors for individual users/devices, for prompting operations of a content generator. The unique content descriptors are delivered to the content generator to provide to the user/device unique content experiences for the particular user/device. Some further nonexclusive examples follow:

### Unique/Dynamic Text

Creates text-based messages for the user/device and delivers them through text, audio, video, or other communications platforms.

### Unique/Dynamic Music

Creates a unique genre of music customized for the user/device and then creates custom songs that are relevant to user/device interests, stage of life, recent experiences, and expected events.

### Unique/Dynamic Art

Populates a user/device's apartment with unique/dynamic art and changes the art based on the user/device additional inputs of preference and frequency among other things.

### Unique/Dynamic TV & Film

Creates unique TV and film content relevant to the user/device interests, stage of life, recent experiences, and expected events.

### Unique/Dynamic Content/Experiences for Virtual Reality

Render an alternative version of an actual lived experience of the user/device, for enjoyment, therapeutic, or new discovery purposes.

### Unique/Dynamic Content/Experiences for Gaming

Creates personalized gaming environments for the user/device, and user/device experiences based on the gameplay behavior.

Of course, numerous alternatives and additions are possible in the embodiments for obtaining, adjusting/optimizing, and delivering unique content descriptors to a generative engine, to provide a unique content experience of the user and user device.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for generating unique descriptors of a user device communicatively connected to a generative engine, comprising:
a descriptor generator communicatively connected to the user device, the descriptor generator
detects actions and inactions of the user device;
transforms the actions and inactions to respective unique descriptor for the user device; and
makes available the respective unique descriptor to the generative engine for delivering unique instructions to the user device.

2. The system of claim 1, wherein the descriptor generator transforms the actions and inactions to optimize the respective unique descriptor for the unique instructions to the user device.

3. A system for generating unique descriptors of a user device communicatively connected to a data communications network, a generative engine is communicatively connected to the data communications network, comprising:
a server device communicatively connected to data communications network, the server device intermediates communications of the user device on the data communications network;
a descriptor generator communicatively connected to the server device, the descriptor generator
detects actions and inactions of the user device on the data communications network;
transforms the actions and inactions to respective unique descriptor for the user device; and
makes available the respective unique descriptor to the generative engine for delivering unique instructions to the user device.

4. The system of claim 3, further comprising:
a social media network server device of a social media network communicatively connected to the data communications network, the social media network server device intermediates communications of the user device in the social media network and communicatively connects to the descriptor generator;
wherein the descriptor generator further transforms actions and inactions of the user device in the social media network to respective unique descriptor for the user device.

5. A method, comprising:
detecting indicators of actions and inactions of a user device communicatively connected to a data communications network;
delivering the indicators to a descriptor generator communicatively connected to the data communications network;
transforming the indicators to a prompt of respective unique descriptor for the user device;
delivering the prompt to a generative learning engine communicatively connected to the data communications network.

6. The method of claim 5, further comprising:
collecting other indicators of actions and inactions of the user device by a social media network server device;
receiving the other indicators by the descriptor generator;
wherein the transforming includes the other indicators.

7. The method of claim 5, further comprising:
collecting similar indicators of actions and inactions of other user devices communicatively connected to the data communications network;
receiving the similar indicators by the descriptor generator;
wherein the transforming includes the similar indicators.

8. The method of claim 6, further comprising:
collecting similar indicators of actions and inactions of other user devices communicatively connected to the data communications network;
receiving the similar indicators by the descriptor generator;
wherein the transforming includes the similar indicators.
